(19) United States
(12) Patent Application Publication
(10) Pub. No.: US 2014/0300965 A1
(43) Pub. Date: Oct. 9, 2014

(54) IMAGE DISPLAY DEVICE UNIT HAVING ADHESIVE LAYER AND IMAGE DISPLAY DEVICE THAT USES SAID UNIT

(71) Applicants: Kentaro Takeda, Ibaraki-shi (JP); Tadashi Kojima, Ibaraki-shi (JP)

(72) Inventors: Kentaro Takeda, Ibaraki-shi (JP); Tadashi Kojima, Ibaraki-shi (JP)

(73) Assignee: NITTO DENKO CORPORATION, Ibaraki-shi, Osaka (JP)

(21) Appl. No.: 14/351,693

(22) PCT Filed: Sep. 14, 2012
(86) PCT No.: PCT/JP2012/073706

§ 371 Date: Apr. 14, 2014

(30) Foreign Application Priority Data
Oct. 14, 2011 (JP) 2011-226327

(51) Int. Cl. G02B 1/10

(52) U.S. Cl. CPC G02B 1/105
USPC 359/513

(57) ABSTRACT

Invention provides unit for image display device in which optical film laminate and panel for image display device are laminated with adhesive layer therebetween. Optical film laminate includes polarizer, polarizer protection functional layer laminated to one surface of polarizer, and surface protection layer laminated to surface of polarizer that is opposite to surface that contacts polarizer protection functional layer. An adhesive layer is laminated to surface of polarizer protection functional layer that is opposite to surface that contacts the polarizer. A panel for image display device is laminated to surface of the adhesive layer that is opposite to surface that contacts the polarizer protection functional layer. Elastic modulus of the adhesive layer, which has been cured, at a temperature of 25° C., is greater than or equal to 1/50 of elastic modulus of layer, from among the layers included in optical film laminate, having smallest elastic modulus.

### TECHNICAL FIELD

This invention relates to an image display device having an adhesive layer, and specifically to (i) a unit for an image display device, in which deterioration of surface hardness of an optical film laminate, compared to a case of measuring the surface hardness of the optical film laminate by itself, is suppressed by laminating the optical film laminate and a panel for the image display device via an adhesive layer that has a specified elastic modulus, and (ii) an image display device that uses the unit.

### BACKGROUND TECHNOLOGY

A polarizer that is manufactured by stretching a polyvinyl alcohol resin (hereafter referred to as a “PVA resin”) can be easily divided or broken in a stretching direction. Because of this, in general, instead of being used by itself as a unit, a polarizer is used in a form of an optical film laminate, both sides of which have a polarizer protection functional layer formed thereon for protecting the polarizer and improving durability. In general, a transparent protection film, such as triacetylcellulose (TAC), is used for the polarizer protection functional layers. There are cases in which an optical film laminate is used in which the function is further improved by laminating a layer having an ultraviolet ray absorption function, or the like, on a protection film. Recently, there are cases in which a phase difference film for optical compensation is used as a polarizer protection functional layer.

In general, a unit for an image display device, which is used for an image display device, bonds such an optical film laminate to a substrate of a panel for an image display device via a layer of agglutinant. An agglutinant that is used when a panel for an image display device and an optical film laminate are bonded together can be defined so as to have the following characteristics.
It has high viscosity and is a semisolid substance with a low elastic modulus. By adding pressure, it is bonded with a body to be adhered.
Even after bonding, it can be exfoliated from the body to be adhered.
The state of the agglutinant does not change in the bonding step.

An agglutinant with such characteristics is one type within a broad range of adhesives. As the agglutinant exists between two bodies to be adhered and pressure is added, adhesive strength is manifested. Thus, it is also called a “pressure-sensitive adhesive.” In this specification, “agglutinant” refers to such a “pressure-sensitive adhesive.”

In order to suppress deterioration of viewability due to damage to a surface of an optical film laminate that is bonded to a panel for an image display device and put into actual use, a damage suppression function is applied to a surface of the viewing side of the optical film laminate. In general, this function is realized by laminating a hard coating layer on a surface of a polarizer or a surface of a polarizer protection functional layer on the viewing side of the optical film laminate. A hard coating layer can be obtained by coating a polymerizable composition that uses polyfunctional (meth)acrylate as a main component on a viewing side of the polarizer or the polarizer protection functional layer, and curing the polymerizable composition by irradiating an active energy ray such as an ultraviolet ray. Details of such a hard coating layer are disclosed in, for example, Patent Reference 1.

Additionally, as another means of applying a damage suppression function, a damage suppression function can also be applied to the polarizer protection functional layer itself by increasing hardness of the polarizer protection functional layer, without laminating a hard coating layer on the polarizer protection functional layer. Such a technology is disclosed in, for example, Patent Reference 2.

However, in a conventional unit for an image display device in which an optical film laminate and a panel for an image display device are laminated, in general, an agglutinant is used to bond the optical film laminate and the panel for an image display device together. An agglutinant layer has high viscosity and is a semisolid substance with a low elastic modulus as described above, and it has a weak repulsive force. Thus, if a force is applied to a surface of the optical film laminate, stress is concentrated at the agglutinant layer, which is the layer with the lowest elastic modulus from among the optical film laminate, the agglutinant layer, and the panel for an image display device, and the agglutinant layer is deformed. Once the agglutinant layer is deformed, the optical film laminate is deformed accordingly, and plastic deformations (recesses) are easily generated on the surface on the viewing side. Using ease of generating this plastic deformation as an indicator, a method of measuring pencil hardness using JIS K5600-5-4 (scratch hardness (pencil method)) is generally used. In a unit for an image display device in which an optical film laminate and a panel for an image display device are laminated via an agglutinant layer, even when a hard coating layer is provided, there is a problem that pencil hardness of an optical film laminate significantly deteriorates compared to the case of measuring the optical film laminate alone.

Additionally, in this specification, adhesive is used so as to be distinguished from the above agglutinant and can be defined as a substance with the following characteristics.
Adhesive is originally a liquid with low viscosity having flowability, makes a contact area large by sufficiently wetting body to be adhered when it is coated onto a body to be adhered, and is bonded with the body to be adhered by curing with light irradiation or heat.
By increasing the light irradiation amount or heat amount, the adhesive passes through an adhesion state and is cured.
After bonding, the body to be adhered and the adhesive layer cannot be exfoliated without breaking agglomeration of the body to be adhered and/or the adhesive layer.
An adhesive state irreversibly changes in a bonding step (changes from liquid to solid).

Adhesive with such characteristics is energy curing type adhesive that manifests adhesive strength by curing the adhesive by applying energy such as light or heat to it. Depending on the type of energy to be applied, it is called, for example, “ultraviolet ray curing type adhesive,” “heat curing type adhesive,” or the like.

### PRIOR ART REFERENCES

### Patent References

[Patent Reference 1] Japanese Patent 4360510
[Patent Reference 2] Japanese Published Patent Application 2007-264535

### SUMMARY OF THE INVENTION

### Problems to be Resolved by the Invention

Large, thin, light image display devices, such as are used for home television, are demanded. At the same time, the cost is decreasing. Because of this, it is predicted that optical film laminates used for such an image display device will become larger, thinner, and lighter in the future as well. However, in such a unit for an image display device in which an optical film laminate is laminated on a panel for an image display device via an agglutinant layer, there is a possibility that deterioration of surface hardness of the optical film laminate may become more significant.

In order to control deterioration of surface hardness, using a means of making a hard coating layer thick can also be considered. However, a means of making a hard coating layer thick is not desirable in view of lightness, thinness, and low cost of an image display device. Also, there is a tendency that an optical film laminate has a large curl, which makes it difficult to handle it, and adhesion of the hard coating layer and the optical film laminate becomes poor.

Thus, an object of this invention is to provide a unit for an image display device, and an image display device using the unit, in which even when a thin optical film laminate is used, generation of plastic deformation on a surface of the optical film laminate can be suppressed without making a hard coating layer unnecessarily thick.

### Means of Solving the Problem

The inventors of this invention accomplished this invention based on the knowledge that the above-mentioned problem may be resolved by bonding an optical film laminate and a panel for an image display device, not with an agglutinant, but with an adhesive layer which has a post-curing elastic modulus within a specified range.

In a first mode, this invention provides a unit for an image display device in which an optical film laminate and a panel for an image display device are laminated with an adhesive layer therebetween. The optical film laminate contains a polarizer, a polarizer protection functional layer laminated to one surface of the polarizer, and a surface protection layer that is laminated to a surface of the polarizer that is opposite to a surface that contacts the polarizer protection functional layer, and the optical film laminate has a thickness of 120 μm or less. The adhesive layer is laminated to the surface of the polarizer protection functional layer that is opposite to the surface that contacts the polarizer. The panel for an image display device is laminated to the surface of the adhesive layer that is opposite to the surface that contacts the polarizer protection functional layer. An elastic modulus of the adhesive layer, which has been cured, at a temperature of 25° C. is greater than or equal to 1/50 of an elastic modulus of a layer, from among the layers included in the optical film laminate, in which the elastic modulus is the smallest.

In a second mode, this invention provides a unit for an image display device in which an optical film laminate with a structure different from the optical film laminate of the first mode and a panel for an image display device are laminated with an adhesive layer therebetween. In this mode, the optical film laminate includes a polarizer, polarizer protection functional layers laminated to both surfaces of the polarizer, and a surface protection layer that is laminated to a surface of one of the polarizer protection functional layers that is opposite to a surface that contacts the polarizer, and the optical film laminate has a thickness of 120 μm or less. The adhesive layer is laminated to a surface of the other polarizer protection functional layer that is opposite to the surface that contacts the polarizer. The panel for an image display device is laminated to the surface of the adhesive layer that is opposite to the surface that contacts the [other] polarizer protection functional layer. An elastic modulus of the adhesive layer, which has been cured, at a temperature of 25° C. is greater than or equal to 1/50 of an elastic modulus of a layer, from among each layer included in the optical film laminate, having the smallest elastic modulus.

In an embodiment of this invention, it is preferable that a thickness of an optical film laminate for a unit for an image display device is 120 μm or less and that an elastic modulus of the adhesive layer, which has been cured, at a temperature of 25° C. is greater than or equal to 1/10 of an elastic modulus of a layer, from among the layers included in the optical film laminate, having the smallest elastic modulus.

In another embodiment of this invention, it is preferable that a thickness of an optical film laminate for a unit for an image display device is 100 μm or less and that an elastic modulus of the adhesive layer, which has been cured, at a temperature of 25° C. is greater than or equal to 1/50 of an elastic modulus of a layer, from among the layers included in the optical film laminate, having the smallest elastic modulus.

In another embodiment of this invention, it is preferable that a thickness of an optical film laminate for a unit for an image display device is 100 μm or less and that an elastic modulus of the adhesive layer, which has been cured, at a temperature of 25° C. is greater than or equal to 1/10 of an elastic modulus of a layer, from among the layers included in the optical film laminate, having the smallest elastic modulus.

In another embodiment of this invention, it is preferable that a thickness of an optical film laminate for a unit for an image display device is 120 μm or less and that the elastic modulus of the adhesive layer, which has been cured, at a temperature of 25° C. is in a range of from 1×10⁸ Pa to 1×10¹⁰ Pa.

In an embodiment of this invention, it is preferable that a pencil hardness on an exposed surface of the surface protection layer of the optical film laminate of the unit of an image display device is the same as a pencil hardness at the exposed surface of the surface protection layer when the optical film laminate is measured by itself, or is lower, by one rank, than the pencil hardness at the exposed surface of the surface protection layer when the optical film laminate is measured by itself.

In a third mode, this invention provides an image display device using the unit for an image display device as set forth in any of claims 1-7.

This invention provides a large image display device that is provided with (i) an effect of suppressing the generation of plastic deformation on a surface of an optical film laminate, (ii) lightness, and (iii) thinness by laminating an optical film laminate and a panel for an image display device through an adhesive layer having a specified elastic modulus.

### BRIEF DESCRIPTION OF THE DRAWINGS

FIG. 1 is a cross-sectional view showing a unit for an image display device according to an embodiment of this invention.

FIG. 2 is a cross-sectional view showing a unit for an image display device according to another embodiment of this invention.

FIG. 3 is a diagram showing measurement results of pencil hardness of a surface of an optical film laminate whose thickness is 188 μm, in a laminate of an optical film laminate and glass.

FIG. 4 is a diagram showing measurement results of pencil hardness of a surface of an optical film laminate whose thickness is 137 μm, in a laminate of an optical film laminate and glass.

FIG. 5 is a diagram showing measurement results of pencil hardness of a surface of an optical film laminate whose thickness is 113 μm, in a laminate of an optical film laminate and glass.

FIG. 6 is a diagram showing measurement results of pencil hardness of a surface of an optical film laminate whose thickness is 88 μm, in a laminate of an optical film laminate and glass.

FIG. 7 is a diagram showing measurement results of pencil hardness of a surface of an optical film laminate whose thickness is 52 μm, in a laminate of an optical film laminate and glass.

### EMBODIMENTS TO IMPLEMENT THE INVENTION

The following specifically explains this invention.

### [Optical Film Laminate]

FIG. 1 is a schematic view showing a cross section of a unit 1 for an image display device, including an optical film laminate 10, related to an embodiment of this invention. In the unit 1 for an image display device, on one surface of a panel 30 for an image display device that can be, for example, a liquid crystal display panel or an organic EL display panel, an optical film laminate 10 is laminated via an optically transparent adhesive layer 20. The optical film laminate 10 includes a polarizer 12, a polarizer protection functional layer 14 laminated to one surface of the polarizer 12, and a surface protection layer 16 that is laminated to the other surface of the polarizer 12, that is, to the surface that is opposite to the polarizer protection functional layer 14. In the optical film laminate 10, the surface of the polarizer protection functional layer 14 that is opposite to the surface that contacts the polarizer 12 is laminated to the panel 30 for an image display device via the adhesive layer 20. It is preferable that a thickness of the optical film laminate 10 of the unit 1 for an image display device related to this invention is less than or equal to 120 μm, and more preferably less than or equal to 100 μm. The image display device can be formed by further arranging various types of structural members such as the optical film laminate, another optical functional film, a protection film, a backlight unit, or the like in the unit 1 for an image display device as needed.

A polarizer known by those skilled in the art can be used for the polarizer 12. In general, the polarizer 12 is manufactured by performing (i) dye treatment using a dichroic substance and (ii) stretching treatment on a PVA resin. For the manufacturing method, a method known by those skilled in the art may be used. A thickness of the polarizer 12 is usually in a range of from 20 μm to 30 μm.

In general, a film comprising a thermoplastic resin that is excellent in transparency, mechanical strength, heat stability, moisture shielding property, isotropy, and the like is used as the polarizer protection functional layer 14 that protects the polarizer 12. As examples of such a thermoplastic resin, as known by those skilled in the art, a cellulose resin such as triacetylcellulose (TAC), a polyester resin such as polyethylene terephthalate (PET), and polyethylene naphthalate (PEN), a polyethersulfone resin, a polysulfone resin, a polycarbonate resin, a polyamide resin, a polyimide resin, a polyolefin resin, a (meth) acrylic resin, a cyclic polyolefin resin (norbornene resin), a polyarylate resin, a polystyrene resin, a polyvinyl alcohol resin, and mixtures of these can be listed. Additionally, as the polarizer protection functional layer 14, a film-like glass that can be bent in a rolled shape like a plastic film can also be used. If the film-like glass is too thin, it is difficult to handle it. If it is too thick, it is difficult to bend it. Thus, preferably, a film-like glass having a thickness within a range of from approximately 30 μm to approximately 120 μm is used. In general, as the polarizer protection functional layer 14, a transparent TAC film having a thickness within a range of from approximately 40 μm to approximately 80 μm is often used.

As the adhesive that bonds the polarizer 12 and the polarizer protection functional layer 14, materials known by those skilled in the art, which use a polymer, such as an acrylic polymer, a silicone polymer, polyester, polyurethane, or polyamide as a base polymer, can be appropriately selected.

As the surface protection layer 16 that is laminated to the surface of the polarizer 12 that is opposite to the polarizer protection functional layer 14, materials known by those skilled in the art, for example, materials which use (a) compositions including an ultraviolet curing acrylic resin, such as polyester acrylate, urethane acrylate, or epoxy acrylate, and (b) compositions that improve a crosslinking density of a resin component of a cured film by adding polyfunctional acrylate having a plurality of acryloyloxy groups in these compositions, can be appropriately selected. The surface protection layer 16 can be obtained by methods known by those skilled in the art, for example, forming a cured film by coating these compositions on the polarizer 12 and applying energy such as an ultraviolet ray after they are dried. A thickness of the surface protection layer 16 is preferably 20 μm or less and more preferably in a range of from 3 μm to 10 μm.

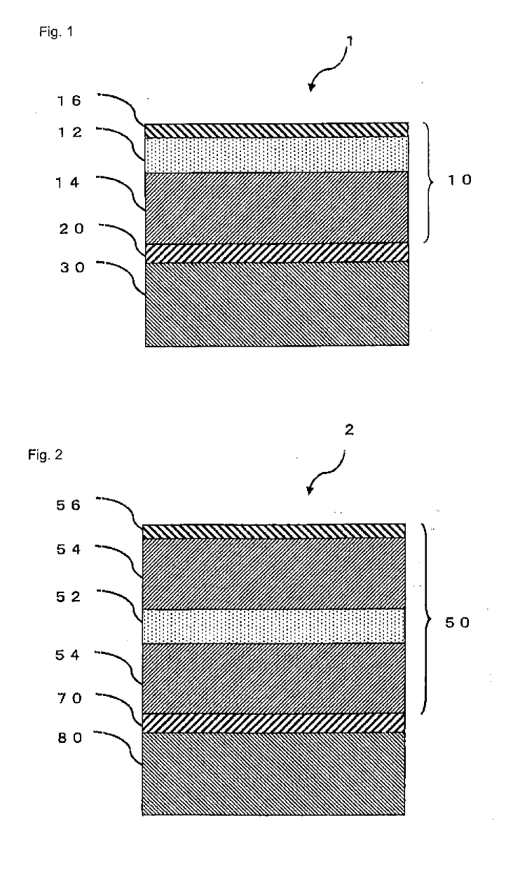

FIG. 2 is a schematic view showing a cross section of a unit 2 for an image display device, including an optical film laminate 50, related to an embodiment of this invention. In the unit 2 for an image display device, the optical film laminate 50 is laminated to one surface of a panel 80 for an image display device that can be used for, for example, a liquid crystal display panel or an organic EL display panel, via an optically transparent adhesive layer 70. The optical film laminate 50 includes a polarizer 52, polarizer protection functional layers 54 laminated to both surfaces of the polarizer 52, and a surface protection layer 56 that is laminated to a surface, opposite to the polarizer 52, of one of the polarizer protection functional layers 54, that is, the polarizer protection functional layer 54 that does not contact the adhesive layer 70. In the optical film laminate 50, (i) the surface of the [other] polarizer protection functional layer 54 that is opposite to the surface that contacts the polarizer 52 and (ii) the panel 80 for an image display device are laminated via the adhesive layer 70 therebetween. It is preferable that a thickness of the optical film laminate 10 of the unit 2 for an image display device related to this invention is less than or equal to 120 μm, and more preferably less than or equal to 100 μm. The image display device can be formed by further arranging various types of structural members such as the optical film laminate, another optical functional film, a protection film, a backlight unit, or the like in the unit 2 for an image display device as needed.

In this embodiment, a film comprising a thermoplastic resin that is the same as the polarizer protection functional layer 14 can be used as the polarizer protection functional layer 54. However, a phase difference film, which has an optical compensation function, can also be used as the polarizer protection functional layer 54. Materials used as such a phase difference film are known by those skilled in the art. A film comprising a cycloolefin resin, a TAC resin, or the like can be used.

### [Panel for Image Display Device]

The panel 30 or 80 for an image display device of the unit 1 or 2 for an image display device can be a panel for an image display device such as a liquid crystal display panel, an organic EL display panel, a plasma display panel, or the like. The surface on which the optical film laminate 1 or 2 [sic. 10 or 50] is laminated via the adhesive layer is a glass or plastic substrate for a panel for an image display device, or a front surface protection plate. These optical film laminates are used so as to demonstrate functions such as image display, antireflection, hue adjustment, or the like in an image display device.

### [Adhesive Layer]

In the unit 1 or 2 for an image display device related to this invention, it is preferable the adhesive layer 20 or 70 that bonds the optical film laminate 1 or 2 [sic. 10 or 50] and the panel 30 or 80 for an image display device is a layer in which an energy curing type adhesive composition including an acrylic compound, an epoxy compound, or a urethane compound is cured by irradiating an energy ray such as a visible ray, an ultraviolet ray, an X ray, an electron beam, or the like, or by heating or the like. But it is not limited to these. As long as the post-curing elastic modulus is within a specified range, any adhesive composition can be used.

### (Elastic Modulus)

The adhesive layer 20 or 70 is used which has an elastic modulus within a specified range. It is preferable that a lower limit of the specified range of the elastic modulus is 1/50 of the elastic modulus of a layer having the lowest elastic modulus, from among the layers included in the optical film laminate 10 or 50, that is, from among the polarizer, the polarizer protection functional layer, and the surface protection layer. More preferably the lower limit is 1/20, and most preferably it is 1/10. It is preferable that the upper limit of the specified range of the elastic modulus is 1×10¹⁰ Pa. It is more preferable that the upper limit of the specified range of the elastic modulus is equal to the elastic modulus of the layer having the highest elastic modulus, from among the layers included in the optical film laminate 10 or 50, that is, from among the polarizer, the polarizer protection functional layer, and the surface protection layer.

If a unit for an image display device is formed by using an adhesive layer or an agglutinant layer in which the post-curing elastic modulus is lower than the above-mentioned lower limit to laminate an optical film laminate and a panel for an image display device, there is a problem that the adhesive layer or the agglutinant layer is deformed when a force is applied to a surface of the optical film laminate, and plastic deformations (recesses) are generated on the surface of the optical film laminate. Meanwhile, if a unit for an image display device is formed by using an adhesive layer or an agglutinant layer in which the post-curing elastic modulus is higher than the above-mentioned upper limit to laminate an optical film laminate and a panel for an image display device, there is a problem that the optical film laminate is easily exfoliated from the panel for an image display device when a shock is applied to the unit.

By laminating the optical film laminate 10 or 50 and the panel 30 or 80 for an image display device via the adhesive layer 20 or 70 which has an elastic modulus within the above-mentioned specified range, even when a force is applied to the surface of the optical film laminate 10 or 50, a problem of generating plastic deformation on the film surface when the optical film laminate and the panel for an image display device are laminated via a layer having a low elastic modulus such as an agglutinant defined in this specification is not detected. It is thought that it is because an adhesive layer with a high elastic modulus has a strong repulsive force, and a force applied to the surface of the optical film laminate is dispersed without being concentrated in a narrow range; thus, deformation can be suppressed by the repulsive force of the optical film laminate itself and of the adhesive layer, or even if the film surface is deformed, the shape of the deformation is shallow and the width is wide, so it cannot be recognized as a deformation.

### (Adhesive Composition)

Thus, the adhesive layer 20 or 70 used for the unit 1 or 2 for an image display device related to this invention has an elastic modulus within a specified range. The following explains adhesive compositions for obtaining such an adhesive layer 20 or 70. In this invention, it is preferable that the adhesive layer 20 or 70 is obtained by curing an energy curing type adhesive composition including an acrylic compound, an epoxy compound, or a urethane compound by irradiating an energy ray, such as a visible ray, an ultraviolet ray, an X ray, an electron beam, or the like, or by heating the adhesive composition.

### <Acrylic Compound>

A polymeric (meta) acrylic monomer can be used as an acrylic compound included in an adhesive composition. In order to impart adhesiveness with respect to a polarizer, and adhesiveness with respect to a glass or plastic substrate, or a front surface protection plate glass, of a panel for an image display device, it is preferable that a polymeric (meta) acrylic monomer includes at least one of a hydroxyl group, a carboxyl group, a cyano group, an amino group, an amide group, a heterocyclic group, a lactone ring group, and an isocyanate ring group. As for a polymeric (meta) acrylic monomer, it is preferable that a monomer containing a monofunctional acryloyl group including only one acryloyl group is a main component. A monomer, including a polyfunctional vinyl or acryloyl group, may be included as a sub-component.

For example, the following substances can be listed as specific examples of an acrylic compound included in an adhesive composition. As acrylic compounds having a hydroxyl group, for example, 2-hydroxyethyl acrylate, 2-hydroxypropyl acrylate, 4-hydroxybutyl acrylate, 2-hydroxyethyl methacrylate, 2-hydroxypropyl methacrylate, or the like are listed. As acrylic compounds having a carboxyl group, for example, acrylic acid, methacrylic acid, or the like are listed. As acrylic compounds having a cyano group, for example, acrylonitrile, methacrylonitrile, or the like are listed. As acrylic compounds having an amino group, for example, dimethylaminoethyl acrylate, dimethylamino propyl acrylate, dimethylaminoethyl methacrylate, diethylaminoethyl methacrylate, diisopropylaminoethyl acrylate, dimethylaminoethyl acrylate, diethylaminoethyl acrylate (DEAA), or the like are listed. As acrylic compounds having an amide group, for example, acrylamide, dimethyl acrylamide, dimethylaminopropylacryl amide, isopropyl acrylamide, diethylacrylamide, hydroxydiethylacrylamide, acryloyl morpholine, or the like are listed. As acrylic compounds having a heterocyclic group, for example, tetrahydrofurfuryl acrylate, tetrahydrofurfuryl methacrylate, glycidyl acrylate, glycidyl methacrylate, pentamethyl piperidinyl methacrylate, tetramethyl piperidinyl methacrylate, or the like are listed. As acrylic compounds having a lactone ring group, for example, γ-butyrolactone acrylate monomer, γ-butyrolactone methacrylate monomer, or the like are listed. As acrylic compounds having an isocyanate group, for example, 2-isocyanatoethyl acrylate monomer, 2-isocyanatoethyl methacrylate monomer, or the like are listed.

### <Epoxy Compound>

A known compound can be used as an epoxy compound included in an adhesive composition. For example, a bisphenol type such as a bisphenol A type, a bisphenol F type, a bisphenol S type, and water additives of these; a novolak type such as a phenol novolak type and a cresol-novolak type; a nitrogen-containing ring type such as a triglicidyl isocyanurate type and a hydantoin type; an alicyclic type; an aliphatic type; a naphthalene type; a low water absorption type such as a glycidylether type and a biphenyl type; a dicyclo type such as a dicyclopentadiene type; an ester type; an ether ester type; and modified types of these are listed. Additionally, an oxetane compound can also be added to these. By adding an oxetane compound to these, viscosity of the adhesive composition can be reduced, and the curing rate can be improved.

For example, the following substances can be listed as specific examples of the epoxy compounds included in the adhesive composition. As a bisphenol type epoxy compound, bisphenol A diglycidyl ether, bisphenol F diglycidyl ether, bisphenol S diglycidyl ether, or the like can be listed. As an alicyclic type epoxy compound, 3,4-epoxycyclohexylmethyl 3,4-epoxycyclohexanecarboxylate, 3,4-epoxy-6-methylcyclohexylmethyl 3,4-epoxy-6-methylcyclohexanecarboxylate, or the like can be listed. As an aliphatic type epoxy compound, 1,4-butanediol diglycidyl ether, 1,6-hexanediol diglycidyl ether, triglycidyl ether of glycerine, triglycidyl ether of trimethylolpropane, or the like can be listed.

### <Urethane Compound>

As a urethane compound included in an adhesive composition, a compound, which has been conventionally used, such as a compound having active hydrogen and an isocyanate compound, can be used. As a compound having active hydrogen, a polyol compound can be listed. As a polyol compound, a polymeric polyol compound, for example, polyether polyol, polyester polyol, polyacryl polyol, and polycarbonate polyol, or the like can be listed. Furthermore, as a polymeric polyol compound, urethane prepolymer can be used, which has a hydroxyl group at an end. Additionally, as a compound having active hydrogen, a compound can be listed, which has carboxylic acid or an amino group. As an isocyanate compound, 2,4-/2,6-tolylene diisocyanate, 4,4-diphenylmethanediisocyanate, hexamethylene diisocyanate, xylylene diisocyanate, isophorone diisocyanate, tetraxylylene diisocyanate, or the like can be listed. As a polymeric isocyanate compound, a polymer compound having an isocyanate group at a molecule end can be listed. Furthermore, short-chain polyol or polyamine can be used as a chain extender, as needed. Additionally, an inorganic filler, which can be represented by silica, calcium carbonate, alumina, titanium oxide, clay, or the like; a catalyst, which can be represented by a tin compound and an amine compound; or an additive such as a leveling agent, a plasticizer, or the like can be added.

From among the above-mentioned compounds, the adhesive composition used for this invention is (a) a compound that has an elastic modulus within the specified range at a temperature of 25° C. when the adhesive layer is cured and formed, or (b) a compound that appropriately mixes two or more of the above compounds, so as to have an elastic modulus within the specified range at a temperature of 25° C. when the adhesive layer is cured and formed.

### <Polymerization Initiator>

A known polymerization initiator can be used as a polymerization initiator when a compound included in the adhesive composition is an acrylic compound or an epoxy compound. In this invention, it is preferable that a photopolymerization initiator is used as a polymerization initiator. By using a photopolymerization initiator, a polymerization reaction is generated by light. Thus, control of the adhesion strength and the state of an adhesive composition used for this invention becomes easy, and an optical film laminate that is bonded with a panel for an image display device does not deteriorate and is not destroyed. As photopolymerization initiators, for example, an alkyl-fenon-based photopolymerization initiator, an acylphosphine oxide-based photopolymerization initiator, a titanocene photopolymerization initiator, and a cationic photopolymerization initiator can be listed. As photopolymerization initiators using an ultraviolet ray, for example, various photopolymerization initiators such as a benzoindole-based photopolymerization initiator, a benzophenone-based photopolymerization initiator, an anthraquinone-based photopolymerization initiator, a xanthone-based photopolymerization initiator, a thioxanthone-based photopolymerization initiator, and a ketal-based photopolymerization initiator, can be listed.

As specific examples of a photopolymerization initiator, acetophenone-based compounds such as 4-(2-hydroxyethoxy)phenyl (2-hydroxy-2-propyl)ketone, α-hydroxy-α, α′-dimethyl acetophenone, methoxy acetophenone, 2,2-dimethoxy-2-phenyl acetophenone, 2, 2-diethoxy acetophenone, 1-hydroxycyclohexyl phenyl ketone, 2-methyl-1-[4-(methylthio)-phenyl]-2-morpholinopropan-1-one; benzoin ether compounds such as benzoin ethyl ether, benzoin isopropyl ether, and anisoin methyl ether; a-ketol compounds such as 2-methyl-2-hydroxypropiophenone; ketal compounds such as benzyl dimethyl ketal; aromatic sulfonyl chloride compounds such as 2-naphthalenesulfonyl chloride; photoactive oxime compounds such as 1-phenone-1,1-propanedione-2-(O-ethoxycarbonyl)oxime; and benzophenone compounds such as benzophenone, benzoylbenzoic acid, 3,3′-dimethyl-4-methoxybenzophenone, 3,3′,4,4′-tetra(t-butyl peroxylcarbonyl)benzophenone; and thioxanthone compounds such as 7-[di(p-toluoyl)-sulfonio]-2-isopropylthioxanthone hexafluoroantimonate and 7-[di(p-toluoyl)-sulfonio]-2-isopropylthioxanthonetetrakis(pentafluorophenyl)borate can be listed.

Energy necessary for a polymerization initiator to generate active species is usually given via one of an optical film laminate and a panel for an image display device to be bonded. Thus, when a photopolymerization initiator is used as a component of an adhesive composition, it is preferable that a photopolymerization initiator that can be used absorbs a wavelength of light that is transmitted through an optical film laminate and a panel for an image display device to be bonded. For example, when (i) an optical film laminate in which a TAC film is used as a polarizer protection functional layer and (ii) a panel for an image display device are bonded, it is preferable that a photopolymerization initiator is used which has absorption of wavelengths longer than 380 nm, which is the wavelength of light that is transmitted through an optical film laminate, such that irradiated light is not absorbed by a light absorbing agent included in the TAC film.

In this invention, when a compound included in the adhesive composition is an acrylic compound or an epoxy compound, as an energy source applied to the adhesive composition, it is preferable that an ultraviolet ray or an electromagnetic wave of a wavelength in the vicinity of an ultraviolet ray is used. If a visible ray is used, a polymerization reaction may proceed due to the effect of surrounding light. There are problems such that control of the reaction may become difficult and that the adhesive composition may be colored because absorption of the visible ray remains due to the remainder of the polymerization initiator. If an infrared ray is used, there are problems such that a polymerization reaction may proceed due to heat, and that control of the reaction may become difficult.

In this invention, it is preferable that after a photoinitiator reacts due to light, there is no absorption in the visible light area, or a degree of absorption in the visible light area is low. In particular, for example, in a liquid crystal display device, it is preferable that in the photoinitiator, there is no absorption, or low absorption, of light of wavelengths in the vicinity of 440 nm, 530 nm, and 610 nm, which are bright line peaks of backlight, so as to not affect hue when visually recognized.

### <Mixing Ratio of Compound and Polymerization Initiator>

The mixing ratio of the acrylic compound or the epoxy compound and the polymerization initiator of an adhesive composition is not particularly limited. However, when the ratio of the polymerization initiator is excessive, problems may occur such that the polymerization reaction proceeds too fast, so control of the reaction becomes difficult, the adhesive composition becomes colored, and dispersion of the polymerization initiator becomes poor. When the ratio of the polymerization initiator is too low, the polymerization reaction takes time, and productivity of a process of bonding with the adhesive composition deteriorates, which is not desirable. For example, if hydroxyethylacrylamide (HEAA) is used as the acrylic compound, and acyl phosphonic oxide-based photoinitiator is used as the polymerization initiator, it is preferable that the adhesive composition contains from 0.3 to 3 parts by weight of the polymerization initiator for 100 parts of the HEAA in the adhesive composition.

<Other Additives that can be Added>

In addition to an acrylic compound, an epoxy compound, or a urethane compound, and a polymerization initiator, as shown below, an additive can also be added to an adhesive composition. For example, in order to improve adhesion of a substrate for a panel for an image display device and an optical film laminate, various Si coupling agents or crosslinking agents can be added to the adhesive composition. Additionally, a polymerization inhibitor can be added to the adhesive composition in order to suppress a dark reaction and increase the usable time of the adhesive composition. Furthermore, by adding to the adhesive composition a photosensitizer that conforms to a transmission wavelength of the optical film laminate, even when a polymerization initiator of a light absorption wavelength that is different from the transmission wavelength of the optical film laminate is used, effects of this invention can be accomplished. Additionally, a conductive material that imparts conductivity, fine particles having birefringence that impart a phase difference, and/or a surfactant that improves surface leveling can be added to the adhesive composition. Furthermore, various curing agents can also be added to the adhesive composition. As a curing agent, a phenol resin, various imidazole-based compounds and their derivatives, a hydrazide compound, dicyandiamide, an isocyanate compound, micro-capsulations of these, or the like can be listed. For example, if a phenol resin is added as a curing agent, a phosphorus-based compound such as triphenylphosphine can be further used together with it as a curing accelerator.

### (Thickness of Adhesive Layer)

A thickness of the adhesive layer 20 or 70 is preferably 20 μm or less and more preferably 10 μm or less. If the thickness of the adhesive layer is more than 20 μm, as a contractive force due to curing of the adhesive layer becomes large, particularly in the case of a large unit for an image display device, a curving force is applied to the panel, so there is a possibility of a display failure.

### [Method of Manufacturing an Image Display Device]

A method of manufacturing a unit for an image display device related to this invention can include the following steps. First, the polarizer 12 or 52, comprising a PVA resin, and the polarizer protection functional layer(s) 14 or 54 are laminated, and the optical film laminate is prepared in which a polarization protection functional layer is laminated to one surface of the polarizer, or in which polarization protection functional layers are laminated to both surfaces of the polarizer. For the optical film laminate in which the polarization protection functional layer 14 is laminated to only one surface of the polarizer, it is preferable that a temporary protection film is laminated to the surface that is opposite to the polarizer protection functional layer 14.

Next, in the case of the unit 1 of FIG. 1, the surface protection layer 16 can be formed by exfoliating the temporary protection film on the surface that is opposite to the polarizer protection functional layer 14, coating and drying a layer including a composition that can form a hard coating layer on the surface of the polarizer 12, and irradiating an energy ray onto this layer and curing the layer. When a temporary protection film is not laminated, the surface protection layer 16 can be formed by coating and drying a layer including a composition that can form a hard coating layer on the surface of the polarizer 12, and irradiating an energy ray onto this layer and curing the layer. As another method, the surface protection layer 16 can be formed by coating and drying a layer including a composition that can form a hard coating layer on a film that can be exfoliated, bonding this layer to a surface of the polarizer 12, irradiating an energy ray so as to cure the layer, and finally exfoliating the film that can be exfoliated. This film that can be exfoliated does not need to be exfoliated, but can be used as a surface protection film that suppresses damage during a manufacturing step. Additionally, as another method, film-like glass, which can be bent like a plastic film, can also be used as the surface protection layer 16. A surface hardness of glass is very much higher than that of a plastic film, and that of a plastic film on which hard coating treatment has been performed, and transparency is also preferable. Conventionally, a film-like glass has not been made into practical use except for a reel-like glass, but a film-like glass in a rolled shape has been recently made into practical use. If the film-like glass used as the surface protection layer 16 is too thin, it is difficult to handle it. If it is too thick, it is difficult to bend it. Thus, a film-like glass having a thickness within a range of from approximately 30 μm to approximately 120 μm is preferable. Thus, the optical film laminate 10 is obtained.

In the case of the unit 2 of FIG. 2, on a surface of the other one of the two polarizer protection functional layers 54 that is opposite to a surface to which the polarizer 52 is laminated, the surface protection layer 56 can be formed by coating and drying a layer including a composition that can form a hard coating layer, and irradiating an energy ray onto this layer and curing the layer. As another method, the surface protection layer 56 can be formed by coating and drying a layer including a composition that can form a hard coating layer on a film that can be exfoliated, bonding this layer to the surface of the other one of the two polarizer protection functional layers 54 that is opposite to the surface to which the polarizer 52 is laminated, irradiating an energy ray so as to cure the layer, and finally exfoliating the film that can be exfoliated. This film that can be exfoliated does not need to be exfoliated, but can be used as a surface protection film that suppresses damage during a manufacturing step. Thus, the optical film laminate 50 is obtained.

Next, in the case of the unit 1 of FIG. 1, on the surface of the polarizer protection functional layer 14 that is opposite to the surface to which the polarizer 12 is laminated, a layer of an adhesive composition is formed. Alternatively, after a layer of an adhesive composition is formed on a release liner and is dried, the layer of the adhesive composition can be transferred to the surface of the polarizer protection functional layer 14 that is opposite to the surface to which the polarizer 12 is laminated. In the case of the unit 2 of FIG. 2, a layer of an adhesive composition is formed on the surface of one of the polarizer protection functional layers 54 that is opposite to the surface to which the polarizer 52 is laminated. Alternatively, after a layer of an adhesive composition is formed on a release liner and is dried, the layer of the adhesive composition can be transferred to the surface of one of the polarizer protection functional layers 54 that is opposite to the surface to which the polarizer 52 is laminated. Any methods of forming and drying the layer of the adhesive composition known by those skilled in the art can be appropriately used. Additionally, any release liner known by those skilled in the art, on which exfoliation treatment is performed to a base film, for example, polyethylene terephthalate, triacetylcellulose, or the like, can be appropriately used.

Next, in both the case of FIG. 1 and the case of FIG. 2, a surface of the layer of the adhesive composition that is opposite to the surface to which the optical film laminate is laminated is laminated to the panel 30 or 80 for an image display device. At this point, in the unit 1 of FIG. 1, a laminate is formed in which the panel 30 for an image display device, the layer of the adhesive composition, the polarizer protection functional layer 14, the polarizer 12, and the surface protection layer 16 are laminated in this order. In the same manner, in the unit 2 of FIG. 2, a laminate is formed in which the panel 80 for an image display device, the layer of the adhesive composition, the polarizer protection functional layer 54, the polarizer 52, the polarizer protection functional layer 54, and the surface protection layer 56 are laminated in this order.

Furthermore, as a method of forming these laminates, as described above, instead of a method in which the layer of the adhesive composition is formed on the optical film laminate, and then the panel for an image display device is laminated to the layer of the adhesive composition, a method can also be used in which the layer of the adhesive composition is formed on the panel for an image display device, and then the optical film laminate is laminated to the layer of the adhesive composition.

Next, the layer of the adhesive composition is cured by irradiating an energy ray such as a visible ray, an ultraviolet ray, an X ray, an electron beam, or the like onto these laminates, or by heating these laminates, so as to form the adhesive layer 20 or 70. By this step, the layer of the adhesive composition is completely cured, and the optical film laminate 10 or 50 and the panel 30 or 80 for an image display device are completely adhered to each other.

### Embodiments

### Formation of Optical Film Laminate

To specifically explain this invention, the following six types of optical film laminates are prepared, of which each has a different thickness.

1. Optical film laminate 1 (manufactured by NITTO DENKO CORPORATION; product number NPF-SEG5224DUHC)

For the optical laminate film 1, a triacetylcellulose (TAC) film, which is a polarizer protection functional layer, a polarizer, a TAC film, and a hard coating layer (HC layer), which is a surface protection layer, are laminated in this order. The overall thickness is 188 μm. The thickness of the polarizer is 22 μm, the thickness of the TAC film is 80 μm, and the thickness of the HC layer is 3 μm. A hardness of the surface of the HC layer of the optical film laminate was a pencil hardness of 3H.

2. Optical film laminate 2 (manufactured by NITTO DENKO CORPORATION; product number NPF-CIG5484DUARC9)

For the optical laminate film 2, an acrylic film, a polarizer, a TAC film, and an HC layer are laminated in this order. The overall thickness is 137 μm. The thickness of the acrylic film is 40 μm, the thickness of the polarizer is 25 μm, the thickness of the TAC film is 60 μm, and the thickness of the HC layer is 12 μm. A hardness of the surface of the HC layer of the optical film laminate was a pencil hardness of 2H.

3. Optical film laminate 3 (manufactured by NITTO DENKO CORPORATION; product number NPF-CVS5774HC)

For the optical laminate film 3, an acrylic film, a polarizer, a TAC film, and an HC layer are laminated in this order. The overall thickness is 88 μm. The thickness of the acrylic film is 20 μm, the thickness of the polarizer is 22 μm, the thickness of the TAC film is 40 μm, and the thickness of the HC layer is 6 μm. A hardness of the surface of the HC layer of the optical film laminate was a pencil hardness of 3H.

### 4. Optical Film Laminate 4

### <Formation of Polarizer>

One surface of a polyvinyl alcohol film (manufactured by KURARAY CO., LTD., VF-PS-N#7500) having a polymerization degree of 2400, a saponification degree of 99.9%, and a thickness of 75 μm was immersed in warm water at a temperature of 30° C. for 60 seconds, was expanded (swelling bath), and caused to expand double. Next, it was immersed in a solution having a density of 3.2% of iodine/potassium iodide (weight ratio=1/7), and while it caused to expand to 3.5 times, the film was dyed (dyeing bath). Next, it was immersed in a solution having 3% of boric acid and 3% of potassium iodide for 20 seconds and was caused to expand to 3.6 times (crosslinking bath). Then, in a solution having 4% of boric acid and 5% of potassium iodide at a temperature of 60° C., it was caused to expand to 6.0 times (extending bath), and in a solution having 3% of potassium iodide, iodine ion impregnation treatment was performed. Finally, it was dried in an oven having a temperature of 60° C. for four minutes, and a polarizer was obtained.

### <Formation of Optical Film Laminate>

Next, an optical laminate film was obtained by bonding a triacetylcellulose (TAC) film (manufactured by FUJIFILM Corporation, TD80UL), which becomes a polarizer protection functional layer, on one surface of the obtained polarizer. Additionally, at this point, a PET film, which is used for a temporary protection film that can be exfoliated, was overlapped with the other surface of the polarizer. As an adhesive that bonds the polarizer and the TAC film, with respect to 100 parts of a polyvinyl alcohol resin having an acetoacetyl group (average polymerization degree: 1200, a saponification degree of 98.5 mol %, acetoacetylization degree: 5 mol %), a water solution was used in which 20 parts of methylolmelanin was dissolved in pure water in a condition having a temperature of 30° C. and that has been adjusted to a solid concentration of 3.2%. After the polarizer and the TAC film were bonded to each other with this adhesive by a roll machine in a condition having a temperature of 30° C., it was dried at 60° C. for five minutes. The adhesive was only used between the polarizer and the TAC. The temporary protection PET film was exfoliated from the optical film laminate, and a hard coating agent on the market was coated on the exfoliated surface, was UV-irradiated, and was cured so as to have a thickness of 8 μm. In the obtained optical film laminate 4, the TAC film, the polarizer, and the HC layer are laminated in this order. The overall thickness is 113 μm, the thickness of the polarizer is 25 μm, the thickness of the TAC film is 80 μm, and the thickness of the HC layer is 8 μm. A hardness of the surface of the HC layer of the optical film laminate was a pencil hardness of 3H.

### 5. Optical Film Laminate 5

For the optical laminate film 5, a TAC film, a polarizer, and a HC layer are laminated in this order. The overall thickness is 50 μm. The thickness of the polarizer is 5 μm, the thickness of the TAC film is 40 μm, and the thickness of the HC layer is 5 μm. The polarizer of the optical film laminate 5 was formed by a method described in Japanese Patent 4691205. A hardness of the surface of the HC layer of the optical film laminate was a pencil hardness of 3H.

### 6. Optical Film Laminate 6

An optical film laminate was obtained by bonding a film-like glass, which becomes a polarizer protection functional film, having a thickness of 50 μm to a surface of a polarizer that was created by the same method as the polarizer of the optical film laminate 4. Additionally, at this point, a PET film, which is used for a temporary protection film that can be exfoliated, was overlapped with the other surface of the polarizer. As an adhesive for bonding the polarizer and the film-like glass, the adhesive was prepared by adding 0.5 part of photoinitiator (manufactured by BASF, IRGACURE 819) to 2-hydroxyethylacrylamide monomer (HEAA) (manufactured by KOHJIN Holdings Co., Ltd.) and dissolving by using an ultrasonic wave while heating at 50° C. in order to increase a dissolution rate. For the adhesive, in order to further increase adhesion with glass, 0.5 part of silane coupling agent (manufactured by Shin-Etsu Chemical Co., Ltd., KBM5103) was added to 100 parts of mixed monomer. The above-mentioned adhesive was dropped onto a film-like glass by a syringe, and the polarizer and the film-like glass were bonded between rolls, using a laminator. Without using an adhesive, a PET film for temporary protection was superimposed on the surface of the polarizer that is opposite to the film-like glass. With respect to this laminate, an ultraviolet ray was irradiated by an ultraviolet ray irradiator (manufactured by EYE GRAPHICS, CO. LTD., UBX 0801-01, output 8 kW (high pressure mercury lamp)) from the glass side, and the adhesive composition was cured. The irradiating conditions were a wavelength of 365 nm, an irradiation strength of 30 mW/cm², and an irradiating time of 30 seconds. The adhesive was used only between the polarizer and the film-like glass. The overall thickness of the obtained optical film laminate 6 is 75 μm. The thickness of the polarizer is 25 μm, and the thickness of the film-like glass is 50 μm. A hardness of the surface of the film-like glass of the optical film laminate 6 was a pencil hardness of 9H or higher.

### [Adhesive Composition Having Acrylic Compound]

For a monomer of an energy curing type adhesive composition including an acrylic compound, a mixed monomer was used, in which the following ingredients were mixed at the ratios (weight ratios) shown in Table 1. Various mixing ratios were determined such that the post-curing elastic modulus at a temperature of 25° C. varies respectively.

HEAA: 2-hydroxyethylacrylamide (manufactured by KOHJIN Holdings Co., Ltd.)
4-HBA: 4-hydroxybutyl acrylate (manufactured by OSAKA ORGANIC CHEMICAL INDUSTRY LTD.)
ACMO: Acryloyl morpholine (manufactured by KOHJIN Holdings Co., Ltd.)
THFA: Acrylic acid tetrahydrofurfuryl (manufactured by Tokyo Chemical Industry Co., Ltd.)

TABLE 1

| | | | | | Post-Curing |
|---|---|---|---|---|---|
| Adhesive | | | | | Elastic Modulus |
| Composition | HEAA | 4-HBA | ACMO | THFA | (Pa) |
| 1 | 100 | — | — | — | 2.52 × 10⁹ |
| 2 | 70 | 30 | — | — | 2.01 × 10⁹ |
| 3 | 50 | 50 | — | — | 6.02 × 10⁸ |
| 4 | 30 | 70 | — | — | 1.98 × 10⁷ |
| 5 | — | — | 80 | 20 | 2.55 × 10⁹ |
| 6 | — | — | 65 | 35 | 1.95 × 10⁹ |
| 7 | — | — | 31 | 69 | 1.20 × 10⁹ |
| 8 | — | — | 20 | 80 | 2.56 × 10⁸ |

The adhesive compositions 1-8 were prepared by adding 0.5 part of a photoinitiator (manufactured by BASF, IRGACURE 819) to 100 parts of each of the mixed monomers in which ingredients were mixed at the ratios shown in Table 1 and dissolving by using an ultrasonic wave while heating at 50° C. in order to increase a dissolution rate. For the respective adhesive compositions, in order to further increase adhesion with glass, 0.5 part of silane coupling agent (manufactured by Shin-Etsu Chemical Co., Ltd., KBM5103) was added to 100 parts of the mixed monomer.

The above-mentioned adhesive compositions 1-8 were coated onto each of the above-mentioned optical film laminates 1-5, and the optical film laminates 1-6 and glass were bonded. The layer of each adhesive composition was adjusted such that the thicknesses of the cured layers were varied. With respect to these laminates, an ultraviolet ray was irradiated by an ultraviolet ray irradiator (manufactured by EYE GRAPHICS, CO. LTD., UBX 0801-01, output 8 kW (high pressure mercury lamp)) from the optical film laminate side in an environment of a temperature of 80° C., and the adhesive compositions were cured. The irradiating conditions were a wavelength of 365 nm, an irradiation strength of 30 mW/cm², and an irradiating time of three minutes.

Table 1 shows elastic moduli of the cured adhesive compositions 1-8 at a temperature of 25° C. The elastic moduli were measured by the solid viscoelasticity [measurement] device RSA III manufactured by TA Instruments. The measurement samples were created by sandwiching the adhesive compositions 1-8 between PET films on which easy exfoliation treatment had been performed, irradiating an ultraviolet ray by an ultraviolet ray irradiator (manufactured by EYE GRAPHICS, CO. LTD., UBX 0801-01, output 8 kW (high pressure mercury lamp)) in an environment having a temperature of 80° C., curing the adhesive compositions in a film shape, and cutting into a strip shape. The irradiating conditions were a wavelength of 365 nm, an irradiation strength of 30 mW/cm², and irradiating time of three minutes. The following shows the measurement conditions.

Modification mode: tension

### Frequency: 1 Hz

Initial distortion: 0.1%

### Temperature: −40° C.˜200° C.

Temperature raising rate: 10° C./min

### [Adhesive Composition Including an Epoxy Compound]

The following materials are used as main components of an energy curing type adhesive composition including an epoxy compound.

Epolight 80MF (manufactured by KYOEISHA CHEMICAL Co., LTD.)

Epolight 100MF (manufactured by KYOEISHA CHEMICAL Co., LTD.)

Epolight 40MF (manufactured by KYOEISHA CHEMICAL Co., LTD.)

10 parts of oxetane compound was added to 90 parts of each of these materials so as to obtain three types of mixtures. OXT221 manufactured by TOAGOSEI CO., LTD. was used for the oxetane compound. Additionally, the following adhesive compositions 9-11 were prepared by mixing 3 parts of photoacid generator and 0.5 part of sensitizer with 100 parts of each of these mixtures.

TABLE 2

| | | | | | Post- |
|---|---|---|---|---|---|
| | | | | | Curing |
| | | | | | Elastic |
| Adhesive | Epolight | Epolight | Epolight | | Modulus |
| Composition | 80MF | 100MF | 40E | OXT221 | (Pa) |
| 9 | 90 | — | — | 10 | 1.01 × 10⁹ |
| 10 | — | 90 | — | 10 | 5.90 × 10⁸ |
| 11 | — | — | 90 | 10 | 1.81 × 10⁷ |

The adhesive compositions 9-11 were coated onto each of the above-mentioned optical film laminates 1-6 such that the thicknesses of the layers were varied, and an ultraviolet ray was irradiated by an ultraviolet ray irradiator (manufactured by EYE GRAPHICS, CO. LTD., UBX 0801-01, output 8 kW (high pressure mercury lamp)) in an environment of a temperature of 25° C. The irradiating conditions were a wavelength of 365 nm, an irradiation strength of 30 mW/cm², and an irradiating time of two second. Next, these optical film laminates were bonded to glass, an ultraviolet ray was irradiated by an ultraviolet ray irradiator from the optical film laminate side, and the adhesive compositions were cured. The irradiating conditions were a wavelength of 365 nm, an irradiation strength of 30 mW/cm², and an irradiating time of three minutes. Table 2 shows elastic moduli of the adhesive compositions 9-11, which have been cured, at a temperature of 25° C. Elastic moduli were measured in the same manner as for the adhesive compositions 1-8.

[Adhesive Composition including a Urethane Compound]

The following materials are used as an energy curing type adhesive composition including a urethane compound, and are defined as adhesive compositions 12-14.

W-6020 (manufactured by Mitsui Chemicals, Inc.)

W-405 (manufactured by Mitsui Chemicals, Inc.)

W-6061 (manufactured by Mitsui Chemicals, Inc.)

The adhesive compositions 12-14 were coated onto each of the above-mentioned optical film laminates 1-6 such that thicknesses of the layers were varied, and were heated at a temperature of 110° C. for one hour. Next, these optical film laminates were bonded to glass. Table 3 shows elastic moduli of the adhesive compositions 12-14, which have been cured, at a temperature of 25° C. Elastic moduli were measured in the same manner as for the adhesive compositions 1-8.

TABLE 3

| | | | | Post-Curing Elastic |
|---|---|---|---|---|
| Adhesive | | | | Modulus |
| Composition | W-6020 | W-405 | W-6061 | (Pa) |
| 12 | 100 | — | — | 3.93 × 10⁸ |
| 13 | — | 100 | — | 8.73 × 10⁸ |
| 14 | — | — | 100 | 1.21 × 10⁷ |

### [Agglutinant]

An acrylic agglutinant was prepared as follows. First, after 95 parts by weight of butyl acrylate, 3.0 parts by weight of acrylic acid, 0.10 part by weight of 2-hydroxyethyl acrylate, 0.050 part by weight of 2,2-azobisisobutyronitrile, and 200 parts by weight of ethyl acetate were added to a flask having a nitrogen tube and a cooling tube and were sufficiently nitrogen-substituted, a polymerization reaction was performed at 55° C. for 20 hours while stirring in a nitrogen stream, and a solution of an acrylic polymer A of high molecular weight, whose weight average molecular amount was 1,570,000, was obtained. Next, with respect to 100 parts by weight of the above-mentioned acrylic polymer A solution (solid), 0.15 part by weight of dibenzoyl peroxide (one minute half-life: 130.0° C.), 0.080 part by weight of 3-glycidoxypropyltrimethoxysilane as a silane coupling agent, and 0.60 part by weight of an isocyanate-based crosslinking agent (CORONATE L, manufactured by Nippon Polyurethane Industry Co., Ltd.) comprising a tolylene diisocyanate additive of trimethylolpropane as a crosslinking agent were uniformly mixed, and an agglutinant composition was prepared. The agglutinant composition was coated on a polyethylene terephthalate film (manufactured by Mitsubishi Polyester, MRF 38 (addition reaction type silicon)), having a thickness of 38 μm, on which silicone exfoliation treatment had been performed, and was dried at 150° C. for two minutes, and peroxide decomposition treatment was performed. The elastic modulus was measured by the solid viscoelasticity [measurement] device RSA III manufactured by TA Instruments and was 3.41×10⁵ Pa. Additionally, an elastic modulus of agglutinant is low, and the elastic modulus cannot be measured by applying tension to a paper strip-like sample; thus, the elastic modulus was measured by applying torsion shear stress.

### [Elastic Moduli of Optical Film Laminates]

An elastic modulus of each layer comprising the optical film laminates 1-5 was measured by Tensilon. Elastic moduli were obtained from the largest elasticity (tangential linear equation of the maximum slope of an SS curve) immediately before the samples were modified. The TAC film that is a polarizer protection functional layer is TD80UL manufactured by Fujifilm Corporation. The acrylic film is a transparent protection film (having a thickness of 40 μm) made by film-extruding a (meta) acrylic resin having a lactone ring structure in which, in the following general formula (I), R₁ is a hydrogen atom and R₂ and R₃ are a methyl group [weight ratio of copolymerization monomer: methyl methacrylate/2-(hydroxymethyl)methyl acrylate=8/2; a high lactone ring formation rate—approximately 100%], and biaxially stretching the extruded film.

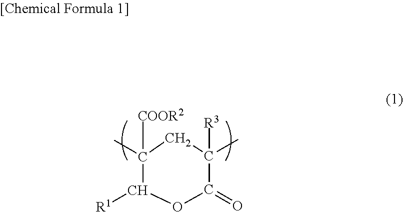

For the polarizer, a PVA [resin] was stretched, so the MD elastic modulus (elastic modulus in an absorption axis direction) was measured. However, the TD elastic modulus (elastic modulus in a direction crossing an absorption axis) was not measured because the polarizer was split. Table 4 shows the measurement result of the elastic modulus of each layer. According to the results of Table 4, in the optical film laminate, the elastic modulus of the TAC film becomes the smallest. Because of this, the elastic modulus of the adhesive layer of this application is regulated by using average values of the elastic modulus of the TAC film as a reference. Furthermore, the elastic moduli of the film-like glass are 5×10¹⁰ Pa or more, which is a different order of magnitude than the elastic moduli of other polarizer protection functional layers.

TABLE 4

| | MD Elastic Modulus | TD Elastic Modulus | Average Value |
|---|---|---|---|
| TAC Film | 2.8 × 10⁹ Pa | 5.0 × 10⁹ Pa | 3.9 × 10⁹ Pa |
| Polarizer | 1.2 × 10¹⁰ Pa | — | — |
| Acrylic | 1.2 × 10⁹ Pa | 1.3 × 10⁹ Pa | 1.3 × 10⁹ Pa |
| Film | | | |

### [Evaluation of Surface Hardness]

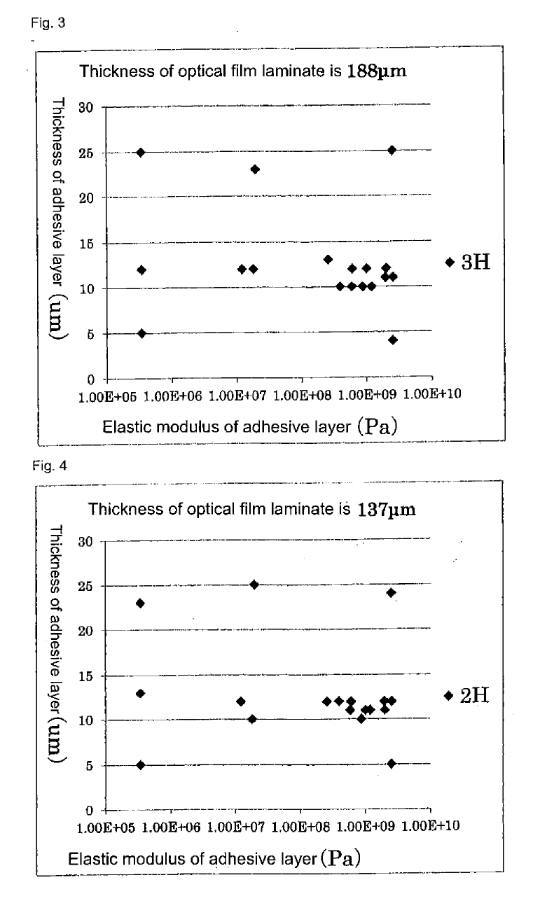

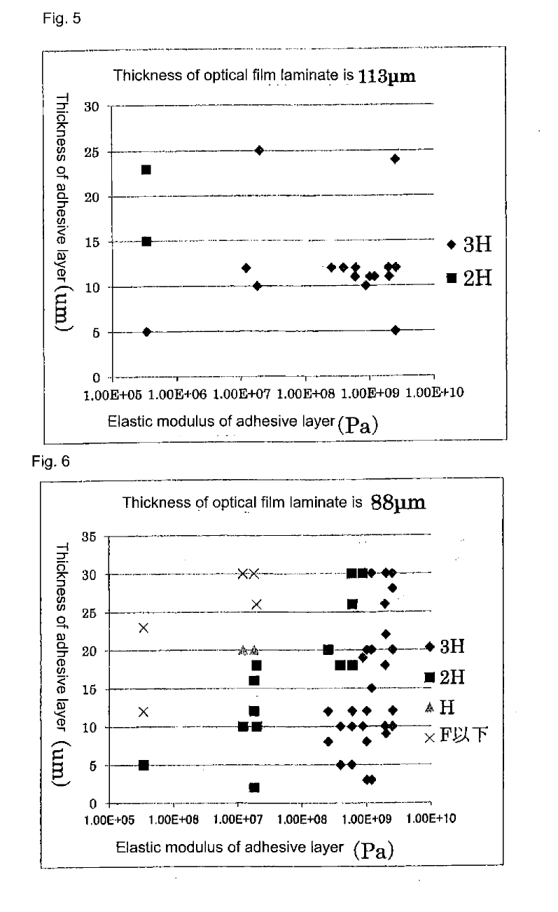

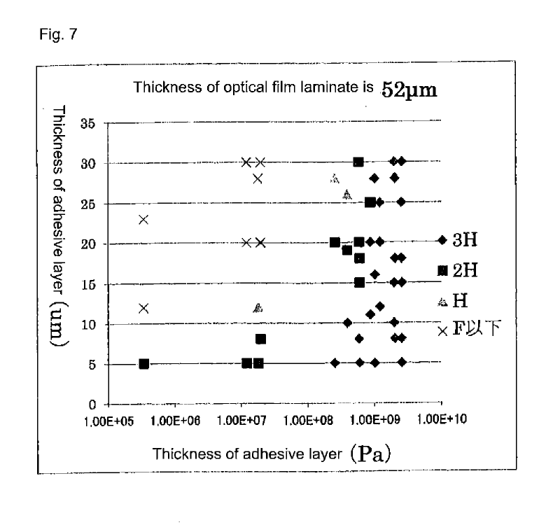

Laminate units were created by bonding each of the optical film laminates 1-6 with glass, using the adhesive compositions 1-14 having various thicknesses and an agglutinant. A method of bonding the adhesive compositions 1-14 with an agglutinant was explained above. A surface hardness of the outermost surface of the laminate (that is, the HC layer or the film-like glass) was measured for each laminate unit of the optical film laminates 1-6 and glass. The surface hardness was evaluated by scratching the surface of the laminate and using as an upper limit a pencil hardness at which plastic deformation (pressure scratching) is not generated on the surface, based on JIS K5600-5-4 (scratching hardness (pencil method)). FIGS. 3-7 show graphs plotting measurement results. FIGS. 3-7 are measurement results concerning laminate units using the optical film laminates 1-5, respectively. In each diagram, the horizontal axis shows the elastic modulus of the adhesive layer, and the vertical axis shows the thickness of the adhesive layer. Each point of each diagram shows a measured point for a laminate unit with a different type and thickness of the adhesive layer. Legends such as F, H, 2H, and 3H of the diagrams show pencil hardness.

FIGS. 3-7 show that regardless of the thickness and the elastic modulus of the adhesive layer and the agglutinant layer, a surface hardness of a laminate unit using an optical film laminate 1 (the surface hardness of the optical film laminate by itself is 3H) having a thickness of 137 μm or more and an optical film laminate 2 (the surface hardness of the optical film laminate by itself is 2H) is not seen to be lower than the surface hardness when the optical film laminate was measured by itself. It was recognized that when the elastic modulus decreased, or as the thickness of the adhesive layer became thick, the surface hardness of the laminate units using the optical film laminates 3-5 having a thickness of 113 μm or less (for each case, the surface hardness of the optical film laminate by itself is 3H) was seen to become lower than the surface hardness when the optical film laminate was measured by itself. However, the surface hardness of the laminate units using the optical film laminates 3-5 was hard enough that there was no problem with actual use, regardless of the thickness of the adhesive layer, if an elastic modulus of the adhesive layer at a temperature of 25° C. was greater than or equal to 1/50 Pa of an elastic modulus of the layer, from among the layers comprising the optical film laminate, having the smallest elastic modulus. Additionally, regardless of the thickness of the adhesive layer, if an elastic modulus of the adhesive layer at a temperature of 25° C. was greater than or equal to 1/10 Pa of an elastic modulus of a layer, from among the layers comprising the optical film laminate, having the smallest elastic modulus, the surface hardness of the laminate units using the optical film laminates 3-5 having a thickness of 113 μm or lower was not seen to be lower than the surface hardness when the optical film laminate was measured by itself.

In the laminate units created by bonding the optical film laminate 6 and glass with the various thicknesses of adhesive compositions 1-14 or an agglutinant, the surface hardness became 9H or higher in all combinations, and no decrease of the surface hardness was seen. However, in the laminate unit created by bonding with an agglutinant, when the surface was pushed with sharpened lead of a mechanical pencil, the glass broke. Meanwhile, in case of the laminate units created by bonding with the adhesive compositions 1-14, the glass did not break.

### EXPLANATION OF THE SYMBOLS

1, 2 Units for an image display device
10, 50 Optical film laminates
12, 52 Polarizers
14, 54 Polarizer protection functional layers
16, 56 Surface protection layers
20, 70 Adhesive layers
30, 80 Panels for an image display device

1. A unit for an image display device, comprising:
an optical film laminate including (i) a polarizer, (ii) a polarizer protection functional layer that is laminated to one surface of the polarizer, and (iii) a surface protection layer that is laminated to a surface of the polarizer that is opposite to the surface that contacts the polarizer protection functional layer;
an adhesive layer that is laminated to a surface of the polarizer protection functional layer that is opposite to the surface that contacts the polarizer; and
a panel for an image display device, the panel being laminated to a surface of the adhesive layer that is opposite to the surface that contacts the polarizer protection functional layer,
wherein a thickness of the optical film laminate is 120 μm or less, and
an elastic modulus of the adhesive layer, which has been cured, at a temperature of 25° C. is greater than or equal to 1/50 of an elastic modulus of a layer, from among the layers included in the optical film laminate, having the smallest elastic modulus.

2. A unit for an image display device, comprising:
an optical film laminate including (i) a polarizer, (ii) polarizer protection functional layers that are laminated to both surfaces of the polarizer, and (iii) a surface protection layer that is laminated to a surface of one of the polarizer protection functional layers that is opposite to the surface that contacts the polarizer;
an adhesive layer that is laminated to a surface of the other polarizer protection functional layer that is opposite to the surface that contacts the polarizer; and
a panel for an image display device, the panel being laminated to a surface of the adhesive layer that is opposite to the surface that contacts the other polarizer protection functional layer,
wherein a thickness of the optical film laminate is 120 μm or less, and
an elastic modulus of the adhesive layer, which has been cured, at a temperature of 25° C. is greater than or equal to 1/50 of an elastic modulus of a layer, from among the layers included in the optical film laminate, having the smallest elastic modulus.

3. The unit for an image display device as set forth in claim 1,
wherein the elastic modulus of the adhesive layer, which has been cured, at a temperature of 25° C. is greater than or equal to 1/10 of an elastic modulus of a layer, from among the layers included in the optical film laminate, having the smallest elastic modulus.

4. The unit for an image display device as set forth in claim 1,
wherein the thickness of the optical film laminate is 100 μm or less.

5. The unit for an image display device as set forth in claim 3,
wherein the thickness of the optical film laminate is 100 μm or less.

6. The unit for an image display device as set forth in claim 4,
wherein the elastic modulus of the adhesive layer, which has been cured, at a temperature of 25° C. is in a range of from 1×10⁸ Pa to 1×10¹⁰ Pa.

7. The unit for an image display device as set forth in claim 1,
wherein a pencil hardness at an exposed surface of the surface protection layer of the optical film laminate is the same as a pencil hardness at the exposed surface of the surface protection layer when the optical film laminate is measured by itself, or is lower, by one rank, than the pencil hardness at the exposed surface of the surface protection layer when the optical film laminate is measured by itself.

8. An image display device comprising the unit for an image display device as set forth in claim 1.

9. The unit for an image display device as set forth in claim 2,
wherein the elastic modulus of the adhesive layer, which has been cured, at a temperature of 25° C. is greater than or equal to 1/10 of an elastic modulus of a layer, from among the layers included in the optical film laminate, having the smallest elastic modulus.

10. The unit for an image display device as set forth in claim 2,
wherein the thickness of the optical film laminate is 100 μm or less.

11. The unit for an image display device as set forth in claim 9,
wherein the thickness of the optical film laminate is 100 μm or less.

12. The unit for an image display device as set forth in claim 10,
wherein the elastic modulus of the adhesive layer, which has been cured, at a temperature of 25° C. is in a range of from 1×10⁸ Pa to 1×10¹⁰ Pa.

13. The unit for an image display device as set forth in claim 2,
wherein a pencil hardness at an exposed surface of the surface protection layer of the optical film laminate is the same as a pencil hardness at the exposed surface of the surface protection layer when the optical film laminate is measured by itself, or is lower, by one rank, than the pencil hardness at the exposed surface of the surface protection layer when the optical film laminate is measured by itself.
